(19) United States
(12) Patent Application Publication
(10) Pub. No.: US 2009/0148773 A1
(43) Pub. Date: Jun. 11, 2009

(54) LITHIUM-ION SECONDARY BATTERY CELL, ELECTRODE FOR THE BATTERY CELL, AND METHOD OF MAKING THE SAME

(75) Inventors: Oleg Volkov, Fishers, IN (US); Alexander Mordukhaevich Skundin, Moscow (RU); Peter Novak, Ft. Lauderdale, FL (US); Tatiana L'vovna Kulova, Moscow (RU); Oxana Yurievna Griegorieva, Moscow (RU)

Correspondence Address: HOWARD & HOWARD ATTORNEYS PLLC, 450 West Fourth Street, Royal Oak, MI, 48067, US

(73) Assignee: ENER1, INC., Ft. Lauderdale, FL (US)

(21) Appl. No.: 11/952,009

(22) Filed: Dec. 6, 2007

(51) Int. Cl. H01M 4/40; H01M 4/48; C01D 15/08

(52) U.S. Cl. 429/231.5; 429/231.8; 429/231.95; 423/179.5

(57) ABSTRACT

An electrode, e.g. a negative electrode, for a lithium-ion battery cell is made from a carbonaceous material, such as a carbon paper, which is lithiated by direct contact with a piece of lithium metal in an atmosphere comprising carbon dioxide (CO₂) gas. A method of making the electrode comprises the step of contacting tightly the carbonaceous material with the piece of lithium metal in the atmosphere. The method further comprises the step of storing the carbonaceous material and the piece of lithium metal in the atmosphere, and optionally, in an electrolyte, for a period of time sufficient to completely lithiate the carbonaceous material. A lithium-ion battery cell comprises the negative electrode, a positive electrode comprising oxides of a transition metal, and a non-aqueous electrolyte.

### FIELD OF THE INVENTION

The present invention generally relates to an electrode comprising a carbonaceous material and lithium, and more specifically to an electrode made in an atmosphere comprising carbon dioxide gas, and to a lithium-ion battery cell and to a method of making the same.

### DESCRIPTION OF THE RELATED ART

Lithium-ion secondary batteries (or cells) are well known in the art. Such batteries are widely used in modern portable electronic devices including cellular phones, camcorders, portable computers, etc. Such batteries also have very good prospects as power sources for electric/hybrid vehicles. Conventional lithium-ion batteries generally consist of a negative electrode made from a carbonaceous material, a positive electrode made from a lithiated oxide of cobalt, nickel or manganese, and a non-aqueous aprotic liquid or polymer electrolyte.

Various kinds of carbonaceous materials have been proposed for the negative electrode, including graphites, cokes, carbon fibers, etc. The aforementioned materials are capable of reversible receiving (intercalating) and supplying (deintercalating) lithium ions. Lithium ions intercalation is a cathodic process, i.e., a process of battery charge, while lithium ions deintercalation is an anodic process, i.e., a process of battery discharge. Generally, charge-discharge capacity of carbonaceous materials is ˜372 mAh/g, which corresponds to a LiC₆ compound. Several other carbonaceous materials with charge-discharge capacity more than 372 mA/h have been mentioned in the literature and likely patented; however such materials exhibit rather high capacity fading during cycling.

Typically, secondary batteries must be assembled from negative and positive electrodes having the same charging level. Traditionally, lithium-ion secondary batteries are assembled in a fully discharging/discharged condition, i.e., negative electrodes are plain non-lithiated carbon, e.g. graphite, whereas positive electrodes are fully lithiated oxides, e.g. Li₂Mn₂O₄, LiCoO₂, etc.

In certain cases, it is believed to be more convenient, and may only be possible, to use electrodes in their fully charged form. One such example of this scenario is an electrode based upon vanadium oxide having the formula V₆O₁₃. In this case, a negative electrode must be fully lithiated before cell assembly. In order to accomplish this, some methods have been proposed in the prior art. For instance, U.S. Pat. No. 5,743,921 (the '921 patent) describes a technique for preliminary cathodic lithiating an active material of negative electrodes in a separate bath with aprotic electrolyte and lithium anode. However, the '921 patent offers only partial lithiating of a carbon material to compensate for so-called irreversible capacity, which is described further below. A similar approach is described in the U.S. Pat. No. 5,595,837 (the '837 patent), which also provides only partial lithiating carbon. In addition, according to the '837 patent, all extra lithium intercalated into carbon must be removed from an electrode before cell assembly. Removal of this extra lithium can be fulfilled, for example, by anodic deintercalation in another separate electrolytic bath, which adds another manufacturing step and thereby increases manufacturing costs of the cell.

U.S. Pat. No. RE 33,306 (the '306 patent), discloses a similar way to preliminarily dope a negative carbon electrode with some amount of lithium (Li), i.e., by pre-lithiating the negative carbon electrode. According to the '306 patent, a negative electrode made from carbonaceous material is brought into to intimate contact with a piece of lithium metal in the course of cell assembly. Just after cell assembly and filling the cell with an electrolyte, the cell is stored for some time sufficient for action of a short-circuit galvanic pair “Li-carbon”. In result, all of the Li is anodically dissolved and cathodically reduced at the carbon surface. However, the proposed amount of Li is only enough for compensating irreversible capacity, but not for intercalating into the carbon body. The '306 patent emphasizes that its method is applicable exclusively for amorphous carbon materials, but not to graphite and graphitized materials. Another similar method of preliminary partial lithiation of a negative carbon electrode directly in an assembled cell is also described in U.S. Pat. No. 6,025,093. U.S. Pat. No. 5,162,176 (the '176 patent) teaches use of a negative electrode made from partially lithiated amorphous carbon material prepared via contact of disperse carbon with lithium powder. To form the carbon material, for example, needle coke is mixed with Li powder and such a mixture is stored in an argon (Ar) gas atmosphere at a temperature of 200° C. for 2 hours. Next, the negative electrode for a lithium-ion battery is manufactured from this partially lithiated carbon material by a technique known for those skilled in the art. As like the '306 patent, the '176 patent has only dealt with amorphous carbon materials, fully ruling out graphite and graphitized materials.

All of the aforementioned references aim to partially lithiate carbon materials for eliminating or decreasing the irreversible capacity. This is a very important point and therefore, will now be discussed in some length. Most carbon materials, including graphite, are catalytically active. When a plain carbon electrode goes into contact with an electrolyte, e.g. a solution of lithium salt in aprotic solvent, of lithium-ion batteries, potential of the plain carbon electrode falls in a range of 1.0 to 3.0 V vs. Li⁺/Li. This steady-state potential is determined by a variety of redox-processes connected in particular with various functional groups present on a surface of the plain carbon electrode. These functional groups can include phenolic groups, lactonic groups, carboxylic groups, ketonic groups, etc. Unfortunately, the qualitative and quantitative composition of the plain carbon electrode is indefinite, which is a cause of fatal irreproducibility of steady-state potential.

During a first cathodic polarization of carbon (both amorphous and crystalline), a number of reductive processes occur at the carbons surface. The main role among these reductive processes relates to solvent reduction. As a result of all of these reductive processes, a passivating layer or a passive film covers the surface of the plain carbon electrode. This passive film is ordinary called a “Solid Electrolyte Interface” or a SEI. The nature, composition, properties and formation mechanism of the SEI has been the object of numerous investigations. It is generally known, that such the SEI has a mosaic structure, and can consist of many materials, such as Li₂CO₃, Li₂O, LiF, RCO₂Li, various alkoxides, as well as nonconductive polymers. The SEI generally has properties of a solid electrolyte with ionic conductivity. Charge-transfer species in the SEI are Li⁺ cations. The SEI plays a decisive role in determining electrode performance, which includes such properties as cyclability (or cycle-life), cycling efficiency, and self-discharge. It is charge (amount of electricity) spent for formation of the SEI that determines the aforementioned irreversible capacity. The SEI hinders a direct contact of an electrolyte with a bare surface of catalytically active carbon material. Thus, the SEI prevents further electrolyte reduction and therefore creates loss of battery capacity. The composition and properties of the SEI and therefore, magnitude of the irreversible capacity, are believed to depend on the type of carbon, electrolyte nature, and film-forming conditions.

Carbon pre-lithiating, as described above, is not the only way to eliminate the irreversible capacity problem. A number of other approaches have been patented and described in scientific papers. For example, U.S. Pat. Nos. 5,616,436; 5,622,793; and 5,660,948; disclose some technologies for manufacturing special kinds of carbons having inherently low irreversible capacity. A popular way to eliminate or diminish the irreversible capacity problem is mild oxidation of the surface of carbon with various oxidants. Corresponding examples can be found in U.S. Pat. No. 5,587,257; and in following scientific publications: E. Peled, C. Menachem, D. Bar-Tow, A. Melman, J. Electrochem. Soc., 143, L4 (1996); and Y. Ein-Eli, V. Koch. J. Electrochem. Soc., 144, 2968 (1997). U.S. Pat. No. 6,096,454 offers a method of surface modification of carbon by preliminary forming the passive film (Li₂CO₃ as a main constituent). To do this, carbon is treated with a proper gas, e.g. carbon dioxide (CO₂) gas, or the carbon is impregnated with a solution of carbonate-bearing substances and is then dried.

A number of patents offer the use of coatings other than genuine carbonate passive films. U.S. Pat. No. 6,027,833 (the '833), describes a complex material consisted of graphitic particles coated with layers of an amorphous carbon. According to the '833 patent, such a coating prevents electrolyte (including propylene carbonate) reduction without hindering lithium intercalation and deintercalation. A similar material is disclosed in U.S. Pat. No. 5,965,296, which is prepared from graphite powder/particles. The graphite particles are oxidized in a liquid or a gas phase and are then coated with an amorphous layer, which can be deposited by pyrolysis. Analogous materials are also disclosed in U.S. Pat. Nos. 5,658,692 and 6,103,423. U.S. Pat. No. 6,218,050 discloses a carbonaceous material coated with a silica film.

Accordingly, there remains an opportunity to provide improved electrodes, such as negative electrodes employing complete preliminary lithiating of carbon, e.g. graphite electrodes, improved methods of manufacturing the same, and improved lithium-ion batteries including such electrodes. This also remains an opportunity to provide electrodes that are irreversible-capacity-free.

### SUMMARY OF THE INVENTION AND ADVANTAGES

The present invention provides an electrode for a lithium-ion battery cell. The electrode is made from a carbonaceous material which is lithiated by direct contact with a piece of lithium metal in an atmosphere comprising carbon dioxide (CO₂) gas. The present invention also provides a method of manufacturing the electrode. The method comprises the step of contacting tightly the carbonaceous material with the piece of lithium metal in the atmosphere. The method further comprises the step of storing the carbonaceous material and the piece of lithium metal in the atmosphere for a period of time sufficient to completely lithiate the carbonaceous material. The present invention further provides a lithium-ion battery cell. The lithium-ion battery cell comprises a negative electrode, a positive electrode, and a non-aqueous electrolyte. The positive electrode comprises oxides of a transition metal.

The present invention provides an electrode, e.g. a negative electrode, which can be used to make lithium-ion battery cells, such as secondary lithium-ion battery cells. The lithium-ion battery cells of the present invention generally have a high cycle-life, relatively high gravimetric and volumetric energy density, and generally don't suffer from excessive irreversible capacity during a first charge-discharge cycle.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a graph illustrating lithiation dynamics of an embodiment of the present invention;

FIG. 2 is a graph illustrating charge-discharge curves for the embodiment of FIG. 1;

FIG. 3 is a graph illustrating lithiation dynamics of another embodiment of the present invention;

FIG. 4 is a graph illustrating charge-discharge curves for the embodiment of FIG. 3;

FIG. 5 is a graph illustrating lithiation dynamics of yet another embodiment of the present invention; and

FIG. 6 is a graph illustrating charge-discharge curves for the embodiment of FIG. 5.

### DETAILED DESCRIPTION OF THE INVENTION

The present invention provides an electrode for a lithium-ion battery cell. The electrode is typically a negative electrode. As such, the electrode will hereinafter be referred to as the negative electrode. The negative electrode can be used for assembling a lithium-ion battery cell with, for example, a fully charged positive electrode. The negative electrode, and therefore the lithium-ion battery cell, can be stored in a dry condition or it can be wetted by an electrolyte, all of which is further described below.

The negative electrode is made from a carbonaceous material which is lithiated by direct contact with a piece of lithium metal in an atmosphere comprising carbon dioxide (CO₂) gas. The atmosphere can be established and maintained by various methods, such as in a box, directly in a battery cell during manufacture, and/or by other methods known to those skilled in the art. In one embodiment, the atmosphere is plain CO₂ gas, as understood in the art. In other embodiments, the atmosphere further comprises a noble gas. The noble gas can comprise two or more noble gases, e.g. helium (He), neon (Ne), argon (Ar), krypton (Kr), xenon (Xe), radon (Rn), and combinations thereof. In one embodiment, the noble gas is further defined as Ar gas. If the atmosphere comprises the CO₂ gas and the noble gas, e.g. Ar gas, the CO₂ gas is typically present in the atmosphere in an amount no less than 10%, more typically the CO₂ gas is present in the atmosphere in an amount ranging from 10 to about 90%, on a volume basis. In the aforementioned embodiments, the noble gas typically makes up the remainder of the atmosphere. However, the atmosphere may contain trace amounts of other compounds or impurities, for example oxygen gas and/or water vapor. If the atmosphere contains such impurities, the impurities are preferably kept at a minimum, such as 10 ppm or less, to prevent contamination or interference during lithiation of the carbonaceous material.

The carbonaceous material can comprise various carbon based materials known the art. In certain embodiments, the carbonaceous material is selected from natural graphite, artificial graphite, or combinations thereof. Generally, it is preferred that the carbonaceous material is capable of reversibly intercalating and deintercalating lithium (Li). While the amount of reversibly intercalating lithium is preferred to be as much as possible, the carbonaceous material, while in fully lithiated form, typically corresponds to the formula LiC₆. According to Faraday's law, the abovementioned formula corresponds to an intercalation capacity of about 372 mAh/g. While one formula is described above, it is to be appreciated that other carbonaceous materials can also be used for the present invention, typically those having intercalation capacities of at least about 300 mAh/g. Suitable examples of such carbonaceous materials, for purposes of the present invention, are natural and artificial graphites, partially graphitized or amorphous carbon, petroleum coke, needle coke, various mesophases, etc.

The carbonaceous material can be in a disperse form, such as powders, fibers, flakes, etc. In these embodiments, the negative electrode can be manufactured by any method known in the art, such as by preparing a slurry from a carbonaceous powder and a binder agent, applying the slurry onto/into a current-collector, and drying. If employed, the binder agent can be chosen from such compounds including, but not limited, to, polyvinylidene fluoride (PVDF), ethylene-propylene diene termonomer (EPDM), ethylene vinyl acetate copolymer (EAA), and combinations thereof. Typically, the binder agent is PVDF, if employed

More typically, the carbonaceous material is further defined as a carbon paper. Suitable carbonaceous materials are commercially available from a variety of sources known in the art. One specific example of a suitable carbon paper, for purposes of the present invention, is an untreated Toray carbon paper, EC-TP2-060, commercially available from Electrochem. Inc., of Woburn Mass. Typically, the carbon paper has good mechanical strength, rather high porosity, e.g. up to about 82%, high electronic conductivity, and acceptable intercalation capacity, e.g. up to about 320 mAh/g. It is to be appreciated that other carbon papers may also be used. In addition, the negative electrode may include a combination of two or more of the aforementioned carbonaceous materials.

The piece of lithium metal can be in various forms. For example, the piece of lithium metal can be in the form of, but is not limited to, blocks, wire, strips, plates, foils, etc. Typically, the piece of lithium metal is a foil. The foil can be of various thicknesses, typically having a thickness ranging from about 10 to about 1000μ. A relation between masses of lithium of the piece of lithium metal and carbon of the carbonaceous material typically ranges from about 1:5 to about 1:20, more typically from about 1:7.5 to about 1:15, most typically about 1:10.

The negative electrode is typically made by tight contact of the carbonaceous material with the piece of lithium metal in the atmosphere, more typically by pressing the piece of lithium metal to the carbonaceous material. Generally, a predetermined amount of the lithium metal is brought into tight contact with the carbonaceous material, e.g. the carbon paper. The predetermined amount, i.e., mass, of the lithium metal is typically about 1/20 to about 1/2 of mass of the carbonaceous material. The precise mass of the lithium metal can be easily determined by routine experimentation. It is generally preferable to have some excess amount of the lithium metal after completion of lithiating, which is described below. It is to be appreciated that the precise amount of lithium metal necessary for complete lithiating depends on various factors, such as the nature of the carbonaceous material. It is believed that some excess of lithium metal could be necessary for compensating an irreversible capacity of a positive electrode during a first cycle.

A pressure applied for pressing the piece of lithium metal to the carbonaceous material typically ranges from about 1 to about 10 MPa, more typically from about 2 to about 5 MPa. If the carbonaceous material is the carbon paper or includes the carbon paper, the negative electrode is generally made by pressing the piece of lithium metal to the carbon paper with a magnitude of pressure insufficient to damage the carbon paper. In other words, the pressure is such that the carbon paper is not mechanically destroyed or degraded, such as by cracking, crushing, etc. It is to be appreciated that such pressure depends upon, for example, yield strength of the carbon paper. A variety of devices can be used to apply the pressure. Such devices include, but are not limited to, mechanical presses, hydraulic presses, rollers, vices, etc. The magnitude of pressure is generally high; however, as described above, if the carbon paper is employed, the pressure should be of a magnitude as to not damage the carbon paper. Typically, it is preferred that distribution of the pressure, during application, is as uniform as possible.

After contacting, e.g. pressing, the carbonaceous material with the piece of lithium metal in the atmosphere together, the carbonaceous material and the piece of lithium metal are typically stored in the atmosphere for a period of time. The period of time is sufficient to completely lithiate the carbonaceous material. The period of time is also generally sufficient to form a passive surface film on the carbonaceous material.

In certain embodiments, after and/or during application of pressure, the carbonaceous material, e.g. the carbon paper, and the piece of lithium metal are wetted, i.e., soaked, in a non-aqueous electrolyte. During wetting, the carbonaceous material, the piece of lithium metal, and the non-aqueous electrolyte are typically stored in the atmosphere for the period of time sufficient to completely lithiate the carbonaceous material and to form a passive surface film thereon. Employing this wetting step allows lithiating to proceed at a much faster rate than in a dry condition, i.e., if the non-aqueous electrolyte is not used. Without being bound or limited by any particular theory, it is believed that this phenomenon occurs by functioning of a short-circuited galvanic pair “lithium-carbon” in the presence of the non-aqueous electrolyte. It is also believed that in the case of wetting, lithium intercalation, i.e., lithium entrance into the carbonaceous material, takes place over a majority, if not an entirety, of a wetted surface of carbonaceous material, whereas in the dry condition, i.e., without the non-aqueous electrolyte, this process takes place only in contact points between the carbonaceous material and the piece of lithium metal.

The non-aqueous electrolyte can be any type of non-aqueous electrolyte known in the art. The non-aqueous electrolyte is typically prepared from a lithium salt, which is dissolved in a solvent, typically a non-aqueous solvent and/or an aprotic solvent. Suitable lithium salts and non-aqueous solvents are known in the art. Examples of suitable lithium salts include, but are not limited to, LiClO₄, LiBF₄, LiPF₆, LiAsF₆, LiCF₃SO₃, LiN(CF₃SO₂)₂, LiC(CF₃SO₂)₃, etc. Suitable solvents include, but are not limited to, alkylcarbonates, propylene carbonate (PC), ethylene carbonate butylene carbonate, dimethyl carbonate, diethyl carbonate, ethyl methyl carbonate, cyclic ethers, cyclic esters, glymes, lactones, sulfones, y-butyrolactone, tetrahydrofuran, dimethoxyethane (DME), e.g. 1,2-dimethoxyethane, 1,2-diethoxyethane, dioxane, dioxolane (DO), sulfolane, methyl formate, etc. It is to be appreciated that the non-aqueous electrolyte can include any combination of the abovementioned lithium salts and solvents. For example, binary or ternary mixtures of the solvents can be used. The non-aqueous electrolyte can be used in manufacture of the lithium-ion battery cell, which is described further below. In other words, the non-aqueous electrolyte which is used to form the negative electrode can also be used to manufacture the lithium-ion battery cell including the negative electrode of the present invention.

The period of time sufficient to completely lithiate the carbonaceous material is generally determined by observing a color transition of the carbonaceous material. Generally, in the course of interaction between the carbonaceous material, e.g. graphite, and lithium, i.e., in the course of lithium intercalation, the following transformations generally occur: C→LiC₇₂→LiC₃₆→LiC₂₇→LiC₁₈→LiC₁₂→LiC₆. Color of the carbonaceous material, generally changes in the following sequence: black—violet-blue—bright blue—golden-yellow. It is appearance of golden-yellow color that is a sign of lithiating completion, i.e., the color transition becomes a golden-yellow in color when the carbonaceous material is completely lithiated.

The present invention further provides a lithium-ion battery cell. The lithium-ion battery cell can be of various sizes, shapes, and configurations. One or more of the lithium-ion battery cells can be used to make batteries of various sizes, shapes, and configurations. As alluded to above, the lithium-ion battery cell comprises the negative electrode. The lithium-ion battery cell further comprises a positive electrode, and the non-aqueous electrolyte, as described and exemplified above. The positive electrode typically comprises oxides of a transition metal. Typically, the positive electrode is an electrode using vanadium oxides as an active material, more typically using vanadium oxides with the formula VₓO_{y}, wherein x and y are typically positive integers, and y=2*x+1. Other vanadium oxides include vanadium(II) oxide, vanadium(III) oxide, and vanadium(IV) oxide. It is to be appreciated that various vanadium oxides and phases thereof as known to those skilled in the art may be used. An example of a suitable positive electrode, for purposes of the present invention, is described in U.S. Pat. No. 5,792,576. Typically, both the negative and positive electrodes employ the same active material. For example, in one embodiment, both of the electrodes comprise vanadium oxide, e.g. V₆O₁₃, as their respective active material.

The positive electrode can be manufactured by various methods known in the art. The positive electrode generally comprises the active material, as described and exemplified above, a conductive material, and a binder, applied onto/into a proper current collector. The aforementioned current collector can be made from metals and/or alloys, including, but not limited to, nickel, titanium, stainless steel, aluminium, and copper, with the latter generally being preferred. The current collector can be manufactured into various forms, such as a sheet, a strip, a foil, a mesh, a net, a foamed metal plate, etc. In certain embodiments, the positive electrode typically comprises about 100 parts by weight of a V₆O₁₃ powder. In these embodiments, the positive electrode further comprises from about 1 to about 30 parts by weight of the conductive additive and from about 1 to about 20 parts of the binder. Various types of binders known in the art can be used. Typically, the binder is the same one as used to make the negative electrode, such as, but not limited to PVDF. In certain embodiments, the binder comprises a solution of PVDF in a solvent such as N-methyl-2-pyrrolidone, acetone, another ketone known to those skilled in the art, and combinations thereof. The lithium-ion battery cell can be made by various methods known in the art. In certain embodiments, after manufacture of the lithium-ion battery cell, the negative and positive electrodes are in a fully charged position. Specifically, the fully charged negative electrode is completely lithiated and the fully charged positive electrode is completely de-lithiated. It is to be appreciated that the lithium-ion battery cell can also be in other charge positions.

Typically, the lithium-ion battery cell further comprises a separator. The separator can be any type of separator known in the art, and if employed, typically one used for manufacturing lithium-ion battery cells. The separator can be manufactured by various methods known in the art. It is to be appreciated that the present invention is not limited to any particular method of making the lithium-ion battery cell of the present invention.

The present invention yet further provides a method of manufacturing the negative electrode. The method comprises the steps of contacting tightly the carbonaceous material with the piece of lithium metal in the atmosphere, as described and exemplified above. The method further comprises the step of storing the carbonaceous material and the piece of lithium metal in the atmosphere for the period of time sufficient to completely lithiate the carbonaceous material, as described and exemplified above. Generally, the method is carried out in a controlled environment, e.g. in a glove box with a controlled dry gas atmosphere. Other controlled environments may also be used, as understood in the art. In certain embodiments, as alluded to above, the step of contacting tightly is further defined as applying the pressure to the carbonaceous material and to the piece of lithium metal. The pressure may be applied as described and exemplified above. In certain embodiments, as alluded to above, the method further comprises the step of wetting, i.e., soaking, the carbonaceous material and the piece of lithium metal with the non-aqueous electrolyte, typically after the step of contacting and prior to the step of storing. However, it is to be appreciated that the step of wetting may also be carried out during the step of storing and/or during the step of contacting. Typically, the method further comprises the step of observing the color transition of the carbonaceous material during the step of storing to determine the period of time sufficient to completely lithiate the carbonaceous material, as described and exemplified above.

The following examples, illustrating the electrodes, e.g. the negative electrodes, the method, and the lithium-ion battery cells of the present invention, are intended to illustrate and not to limit the invention.

### EXAMPLES

Three examples of inventive electrodes, more specifically, negative electrodes, were prepared. To prepare all of the examples, a small piece of lithium metal with thickness of ˜100μ, and surface area of ˜0.2 cm² was rolled onto a current collector made from a nickel foil. This assembly was pressed onto a leaf of a carbon paper. The carbon paper has a thickness of 200μ, a square shape of 2 cm², and a mass of 0.016 g.

For Example 1, the assembly is pressed onto the leaf with a pressure ranging from 2 to 3 MPa. The negative electrode was then stored/kept in a dry box for a period of time and was observed for color transition. Initial color of the carbon paper is black, which changed to violet-blue in color, and then to light blue in color. The color transition indicates a process of carbon lithiation. A golden-yellow color indicates complete/full lithiation. For Example 1, complete lithiation occurred after approximately 40 hours.

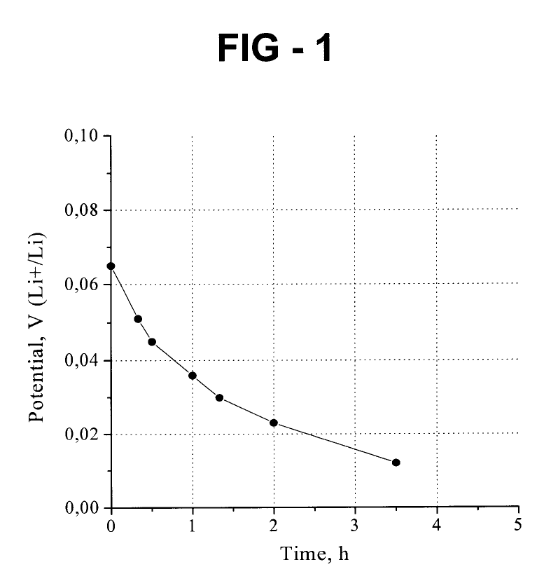

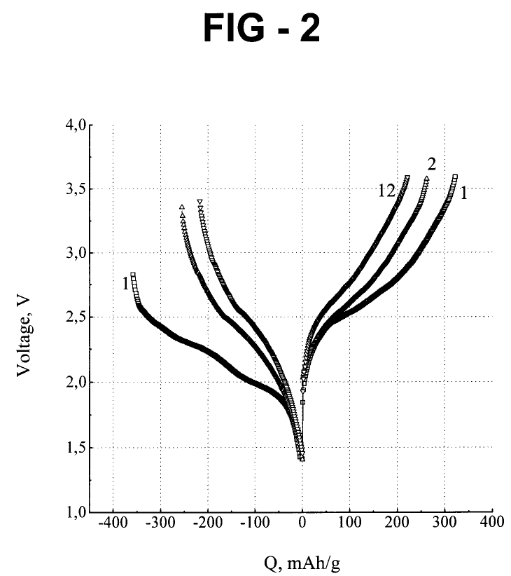

The negative electrode of Example 1 was used for assembling a first battery cell. The first battery cell also contained a positive electrode based on V₆O₁₃ (0.015 g), and a lithium reference electrode. After assembling the first battery cell, and filling the first battery cell with an electrolyte (1M imide in dioxolane (DO)), the potential of the Example 1 negative electrode was equal to +65 mV. During storage of the first battery cell in the open-circuit condition, this potential shifted in the negative direction, and through 3.5 hours it reached +12 mV. FIG. 1 depicts the dynamics of the electrode lithiation in the first battery cell. When the potential of the negative electrode reached +12 mV, cycling was started in a two-electrode mode. Charge-discharge curves for the 1^{st}, 2^{nd} and 12^{th} cycles of the first battery cell are illustrated in FIG. 2. The first battery cell was successfully cycled with specific capacity of about 220 mAh per g of V₆O₁₃. Charging and discharging current densities are equal to about 25 mA per 1 g of vanadate.

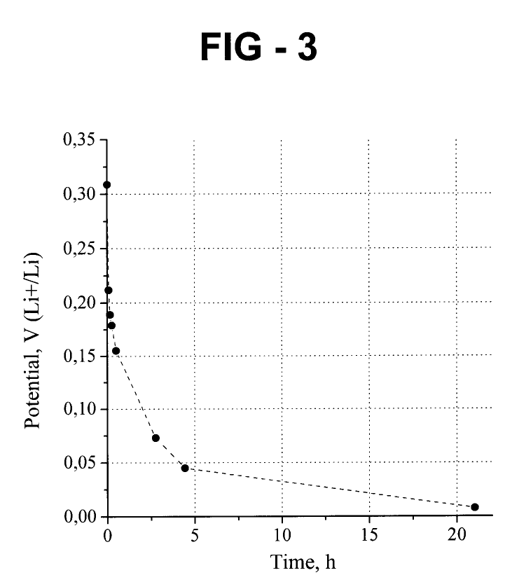

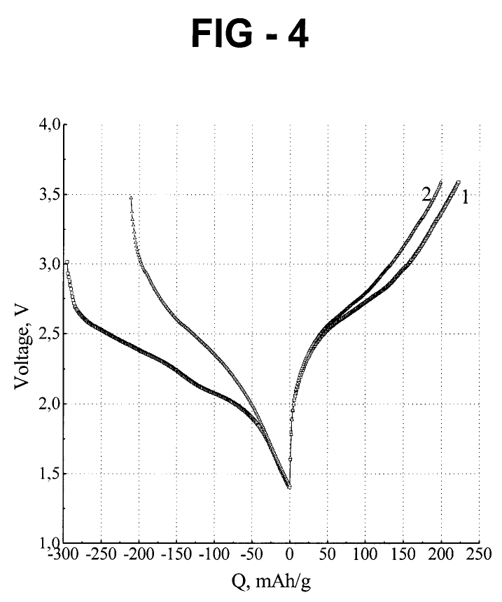

For Example 2, lithiation of negative electrode (as like made above) was fulfilled directly in an assembled second battery cell filled with the electrolyte. The rate of this lithiation process was much faster than that of Example 1, i.e., the period of time was much shorter relative to Example 1. After approximately 2 hours, the potential of the negative electrode reached 50 to 60 mV. This negative electrode was tested in a second battery cell. The second battery cell also contained a positive electrode based on V₆O₁₃ having an active mass of 0.005 g. In other aspects, the second battery cell did not differ from the first battery cell. FIG. 3 depicts the dynamics of the negative electrode lithiation in the second battery cell. Charge-discharge curves for the 1^{st} and 2^{nd} cycles of the second battery cell are illustrated in FIG. 4. Discharge capacity for the second and seventeenth cycles (not shown) were 232 and 182 mAh per 1 g of V₆O₁₃, respectively. Charging and discharging current densities are equal to about 25 mA per 1 g of vanadate.

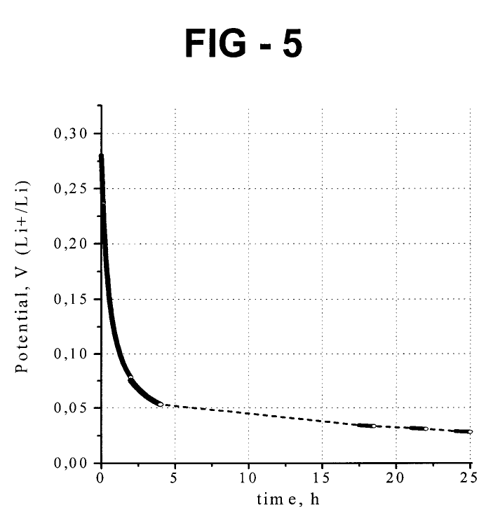

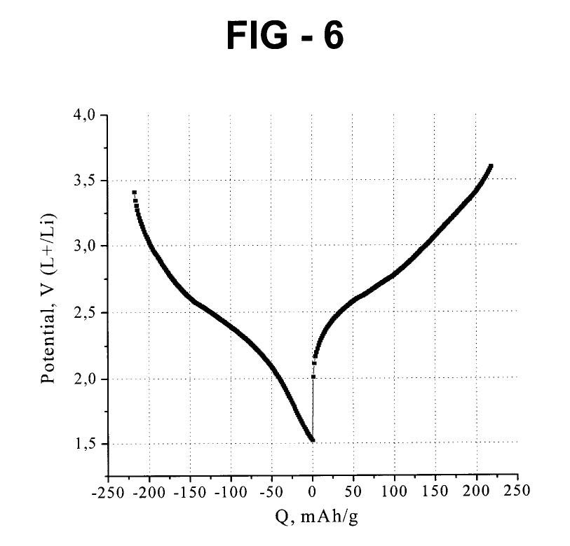

For Example 3, and a third battery cell, all conditions were the same as in the Example 2 and the second battery cell, but an active mass of the positive electrode based on V₆O₁₃ was 0.009 g rather than 0.005 g, and the electrolyte was 1M LiClO₄ in propylene carbonate (PC) and dimethoxyethane (DME) (in a 7:3 PC:DME ratio in parts by weight) rather than 1M imide in dioxolane (DO). FIG. 5 depicts the dynamics of the negative electrode lithiation in the third battery cell. A charge-discharge curve for the 10^{th} cycle of the third battery cell is illustrated in FIG. 6. Charging and discharging current densities are equal to about 25 mA per 1 g of vanadate. Generally, the lithium-ion batteries of the present invention have reduced irreversible capacity loss during the initial charge-discharge cycles.

The present invention has been described herein in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described within the scope of the appended claims.

What is claimed is:

1. An electrode for a lithium-ion battery cell, said electrode being made from a carbonaceous material which is lithiated by direct contact with a piece of lithium metal in an atmosphere comprising carbon dioxide (CO₂) gas.

2. An electrode as set forth in claim 1 wherein said carbonaceous material is selected from natural graphite, artificial graphite, or combinations thereof.

3. An electrode as set forth in claim 1 wherein said carbonaceous material is further defined as a carbon paper.

4. An electrode as set forth in claim 1 being made by tight contact of said carbonaceous material with said piece of lithium metal in said atmosphere.

5. An electrode as set forth in claim 4 wherein a relation between masses of lithium of said piece of lithium metal and carbon of said carbonaceous material ranges from about 1:5 to about 1:20.

6. An electrode as set forth in claim 4 being made by pressing said piece of lithium metal to said carbonaceous material with a pressure ranging from about 1 to about 10 MPa.

7. An electrode as set forth in claim 4 wherein said carbonaceous material is further defined as a carbon paper and said electrode is made by pressing said piece of lithium metal to said carbon paper with a magnitude of pressure insufficient to damage said carbon paper.

8. An electrode as set forth in claim 4 wherein said atmosphere further comprises a noble gas.

9. An electrode as set forth in claim 8 wherein said noble gas is further defined as argon (Ar) gas.

10. An electrode as set forth in claim 8 wherein said CO₂ gas is present in said atmosphere in an amount no less than 10%.

11. An electrode as set forth in claim 1 being made by tight contact of said carbonaceous material with said piece of lithium metal in said atmosphere and with subsequent storing said carbonaceous material and said piece of lithium metal in said atmosphere for a period of time sufficient to completely lithiate said carbonaceous material and to form a passive surface film thereon.

12. An electrode as set forth in claim 11 wherein said period of time sufficient to completely lithiate said carbonaceous material is determined by observing a color transition of said carbonaceous material.

13. An electrode as set forth in claim 12 wherein the color transition becomes a golden-yellow in color when said carbonaceous material is completely lithiated.

14. An electrode as set forth in claim 1 being made by tight contact of said carbonaceous material with said piece of lithium metal in said atmosphere and with subsequent wetting said carbonaceous material and said piece of lithium metal by a non-aqueous electrolyte and storing said carbonaceous material, said piece of lithium metal, and said non-aqueous electrolyte in said atmosphere for a period of time sufficient to completely lithiate said carbonaceous material and to form a passive surface film thereon.

15. An electrode as set forth in claim 14 wherein said non-aqueous electrolyte can be used in manufacture of the lithium-ion battery cell.

16. An electrode as set forth in claim 1 wherein said electrode is a negative electrode.

17. A method of manufacturing an electrode for a lithium-ion battery cell, the method comprising the steps of:
contacting tightly a carbonaceous material with a piece of lithium metal in an atmosphere comprising carbon dioxide (CO₂) gas; and
storing the carbonaceous material and the piece of lithium metal in the atmosphere for a period of time sufficient to completely lithiate the carbonaceous material.

18. A method as set forth in claim 17 wherein the step of contacting tightly is further defined as applying a pressure to the carbonaceous material and to the piece of lithium metal.

19. A method as set forth in claim 18 wherein the pressure ranges from about 1 to about 10 MPa.

20. A method as set forth in claim 17 wherein the carbonaceous material is selected from natural graphite, artificial graphite, or combinations thereof.

21. A method as set forth in claim 17 wherein the carbonaceous material is further defined as a carbon paper.

22. A method as set forth in claim 17 wherein the atmosphere further comprises a noble gas.

23. A method as set forth in claim 22 wherein the noble gas is further defined as argon (Ar) gas.

24. A method as set forth in claim 22 wherein the CO₂ gas is present in the atmosphere in an amount no less than 10%.

25. A method as set forth in claim 17 wherein a relation between masses of lithium of the piece of lithium metal and carbon of the carbonaceous material ranges from about 1:5 to about 1:20.

26. A method as set forth in claim 17 further comprising the step of wetting the carbonaceous material and the piece of lithium metal with a non-aqueous electrolyte.

27. A method as set forth in claim 26 wherein the non-aqueous electrolyte can be used in manufacture of the lithium-ion battery cell.

28. A method as set forth in claim 17 further comprising the step of observing a color transition of the carbonaceous material during the step of storing to determine the period of time sufficient to completely lithiate the carbonaceous material.

29. A method as set forth in claim 28 wherein the color transition becomes golden-yellow in color when the carbonaceous material is completely lithiated.

30. A method as set forth in claim 17 wherein the electrode is a negative electrode.

31. A lithium-ion battery cell comprising:
a negative electrode being made from a carbonaceous material which is lithiated by direct contact with a lithium metal in an atmosphere comprising carbon dioxide (CO₂) gas;
a positive electrode comprising oxides of a transition metal; and
a non-aqueous electrolyte.

32. A lithium-ion battery cell as set forth in claim 31 wherein each of said negative and positive electrodes are in a fully charged position.

33. A lithium-ion battery cell as set forth in claim 32 wherein the fully charged position of said negative electrode is further defined as said negative electrode being completely lithiated and the fully charged position of said positive electrode is further defined as said positive electrode being completely de-lithiated.

34. A lithium-ion battery cell as set forth in claim 31 wherein both of said electrodes comprise an active material, said active material being further defined as vanadium oxide.
